(19) United States
(12) Patent Application Publication
(10) Pub. No.: US 2014/0032689 A1
(43) Pub. Date: Jan. 30, 2014

(54) METHOD AND SYSTEM FOR PROCESSING MESSAGE CONTENT THAT IS STORED AT A MESSAGE SERVER

(71) Applicant: Unwired Planet, LLC, Reno, NV (US)

(72) Inventor: Michael BURSTEIN, Redwood City, CA (US)

(73) Assignee: Unwired Planet, LLC, Reno, NV (US)

(21) Appl. No.: 14/041,651

(22) Filed: Sep. 30, 2013

Related U.S. Application Data
(63) Continuation of application No. PCT/US2012/031649, filed on Mar. 30, 2012.
(60) Provisional application No. 61/470,464, filed on Mar. 31, 2011.

(51) Int. Cl. H04L 12/58

(52) U.S. Cl. CPC H04L 51/28
USPC 709/206

(57) ABSTRACT

Methods and systems for processing message content that is stored at a message server are described. In one embodiment, a method for processing message content that is stored at a message server involves mapping access networks to a set of processing rules, receiving a request for message content that is stored at a message server from a client device via one of the access networks, where the request is made according to a messaging protocol, determining from which access network the request was received, and making a decision on processing the requested message content as a function of the access network from which the request was received and the mapping. Other embodiments are also described.

### CROSS-REFERENCE TO RELATED APPLICATIONS

This application is a continuation under 35 U.S.C. §120 of International Application No. PCT/US2012/031649, filed on Mar. 30, 2012 and published in the English Language on Oct. 4, 2012 as WO 2012/135741 which claims priority to US Provisional Patent Application No. 61/470,464 filed Mar. 31, 2011. Each of the above-referenced applications is hereby incorporated by reference in its entirety.

### BACKGROUND

In a conventional messaging system, when a client device, such as a smart phone or a pad computer, fetches an attachment to an email message from a message server, a true copy of the attachment is downloaded from the message server to the client device, regardless of which access network the client device is currently using. In some cases, the attachment may be a large file such as a high resolution image file or a video clip. For example, an image file attachment or a video clip attachment can have a file size in the magnitude ranging from several megabytes to tens of megabytes. Because the fetched attachment can be rather large, the user experience can be negatively impacted if the access network is not able to timely deliver the fetched attachment.

### SUMMARY

Methods and systems for processing message content that is stored at a message server are described. In one embodiment, a method for processing message content that is stored at a message server involves mapping access networks to a set of processing rules, receiving a request for message content that is stored at a message server from a client device via one of the access networks, where the request is made according to a messaging protocol, determining from which access network the request was received, and making a decision on processing the requested message content as a function of the access network from which the request was received and the mapping. Other embodiments are also described.

In another embodiment, a method for processing message content that is stored at a message server is described. The method for processing message content that is stored at a message server involves mapping access networks to a set of compression rules, receiving a request for message content that is stored at a message server from a client device via one of the access networks, wherein the request is made according to a messaging protocol, determining from which access network the request was received, where blocks of Internet Protocol (IP) addresses are assigned to the access networks, and making a decision on compressing the requested message content as a function of the access network from which the request was received and the mapping. Determining from which access network the request was received involves comparing an IP address associated with the request with the blocks of IP addresses and if the IP address associated with the request matches an IP address in one of the blocks of IP addresses, identifying the corresponding access network as the access network from which the request was received. Making the decision on compressing the requested message content involves deciding whether or not to compress the requested message content and if the decision is made to compress the requested message content, selecting a compression technique based on the mapping. The method further involves causing the requested message content to be compressed using the selected compression technique if the decision is made to compress the requested message content. Other embodiments of a method are also described.

Embodiments of a system for processing message content that is stored at a message server are also described. In one embodiment, a system for processing message content that is stored at a message server includes a mapper configured to map access networks to a set of processing rules, a message server configured to store message content and to receive a request for the message content from a client device via one of the access networks, where the request is made according to a messaging protocol, a network determiner configured to determine from which access network the request was received, and a decision maker configured to make a decision on processing the requested message content as a function of the access network from which the request was received and the mapping of the access networks to the set of processing rules. Other embodiments of a system for processing message content that is stored at a message server are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1A depicts a schematic block diagram of one embodiment of a network architecture.

FIGS. 1B and 1C illustrate examples of operations of the network architecture depicted in FIG. 1A.

FIG. 2 depicts a schematic block diagram of another embodiment of a network architecture.

FIG. 3 shows example records in the performance statistics database of FIG. 2.

FIG. 4 shows an example mapping of the mapper of FIG. 2.

FIG. 5 illustrates example operations of the message service system of FIG. 2.

FIG. 6 depicts a computer that includes a processor, memory, and a communications interface.

FIG. 7 is a process flow diagram of a method for processing message content that is stored at a message server in accordance with an embodiment of the invention.

Throughout the description, similar reference numbers may be used to identify similar elements.

### DETAILED DESCRIPTION OF CERTAIN INVENTIVE EMBODIMENTS

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may, but do not necessarily, all refer to the same embodiment.

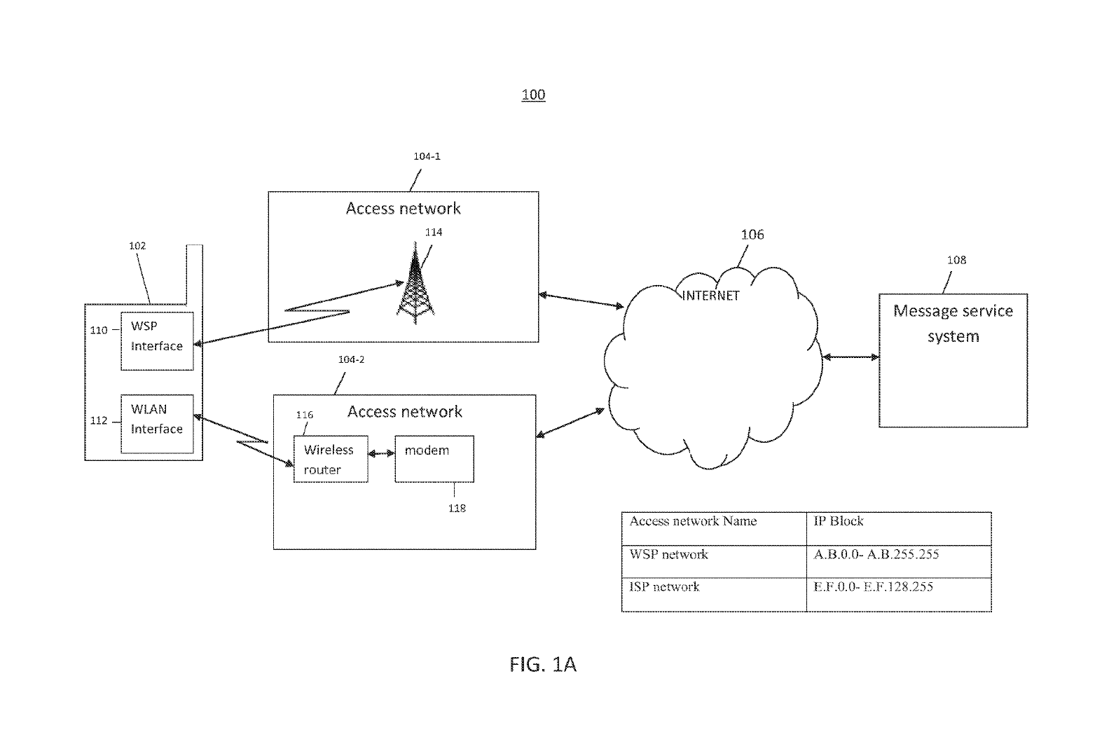

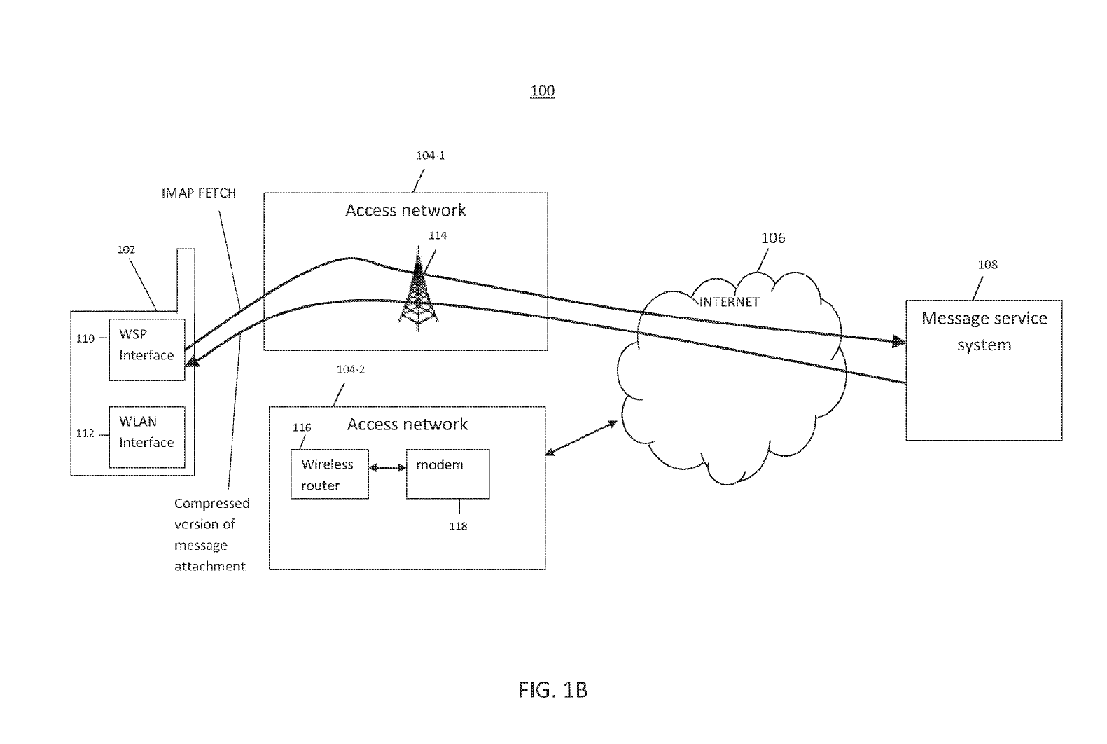

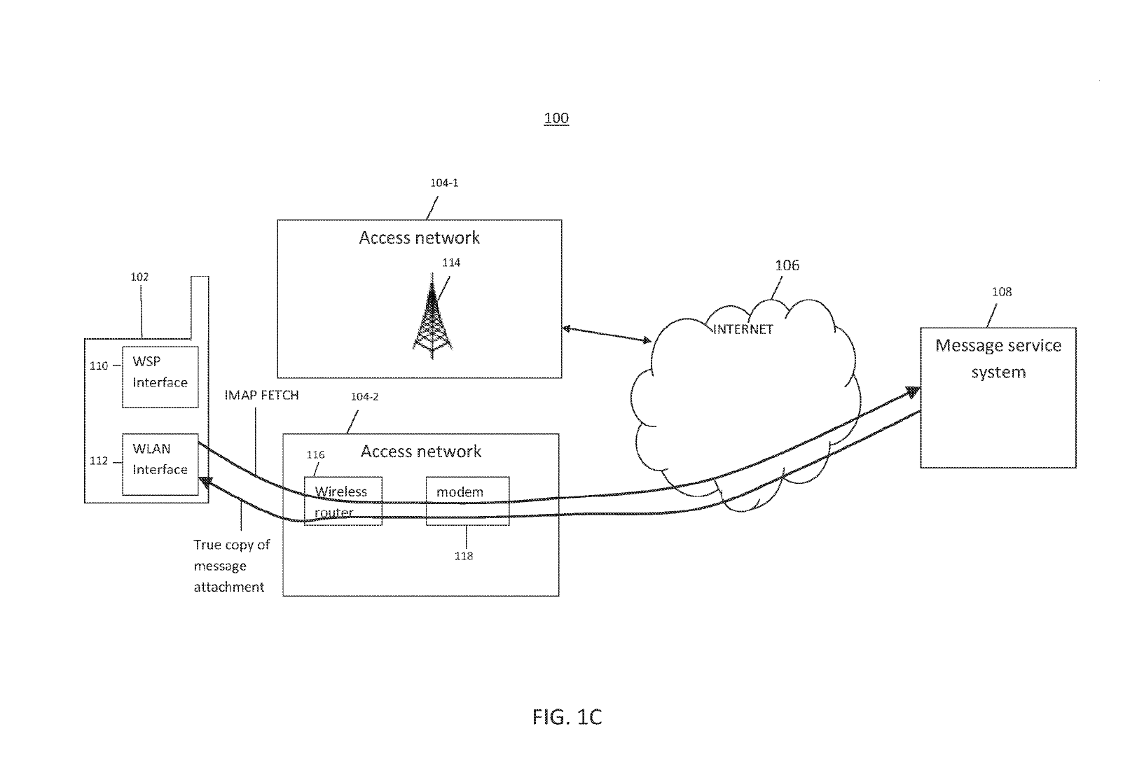

FIG. 1A depicts a schematic block diagram of one embodiment of a network architecture 100 that provides messaging services to a client device 102. The network architecture depicted in FIG. 1 includes a client device 102, access networks 104-1, 104-2, the Internet 106, and a message service system 108. Although the network architecture is depicted and described with certain components and functionality, other embodiments of the network architecture may include fewer or more components to implement less or more functionality. For example, the network architecture may include more than one message service system in some embodiments.

Each of the access networks 104-1, 104-2 of the network architecture 100 is configured to facilitate communications between the client device 102 and the Internet 106. In the embodiment depicted in FIG. 1A, the access network 104-1 is a wireless service provider (WSP) network, such as a 2G, a General Packet Radio Service (GPRS), an Enhanced Data rates for Global System for Mobile Communications (GSM) Evolution (EDGE), a 3G or a 4G cellular network. The WSP network 104-1 includes a radio access network 114, which may include one or more base stations (not shown), with each base station having at least one radio frequency (RF) transceiver. The access network 104-2 is an Internet service provider (ISP) network, such as a dial-up, a digital subscriber line (DSL), or a cable modem based ISP network with one or more wireless access points. The ISP network 104-2 includes a modem 118 to modulate/demodulate signals exchanged between the client device and the Internet and a wireless router 116 that provides a WLAN, such as an IEEE 802.11 WLAN. The modem and the wireless router may be located at the premise of a subscriber of the ISP network 104-2. A private enterprise network can also serve as an access network if client devices within the private enterprise network can access the Internet 106 through the private enterprise network. Although some cellular/wireless/wired access networks are identified herein, it should be understood that the present disclosure is not limited to the cited wireless and wireless access networks.

In the embodiment depicted in FIG. 1A, the WSP network 104-1 is assigned a block of IP address between A.B.0.0 and A.B.255.255 and the ISP network 104-2 is assigned a block of IP address between E.F.0.0 and E.F.128.255, where A, B, E, F represent different positive integers. Because each of the WSP network and the ISP network is assigned a unique block of IP addresses, the access network that the client device is currently using can be identified by comparing an IP address associated with a request for message content by the client device with the blocks of IP addresses assigned to the WSP network and the ISP network. For example, if the IP address associated with a request is A.B.150.130, then the WSP network is identified to be the access network that the client device is currently using. In another example, if the IP address associated with a request is E.F.110.120, then the ISP network is identified to be the access network that the client device is currently using. Although some IP addresses are identified herein, it should be understood that the present disclosure is not limited to the cited IP addresses.

The client device 102 is in the communications ranges of the WSP network 104-1 and the ISP network 104-2. In the embodiment depicted in FIG. 1A, the client device is a smart phone that is associated with a subscriber to a wireless service provider that operates the radio access network 114 of the WSP network and has access to the WLAN provided by the wireless router 116 of the ISP network. The smart phone includes a WSP interface 110 and a WLAN interface 112. The WSP interface is used for communications between the smart phone and the radio access network. The WLAN interface is used for communications between the smart phone and the wireless router. The client device is configured to request message content from the message service system 108 on behalf of a user via one of the WSP network and the ISP network. The client device may be further configured to render received message content for presenting to the user. The user may be a single person, multiple persons, other entity or entities.

The message service system 108 is configured to receive one or more requests for message content from the client device 102 via the WSP network 104-1 and/or the ISP network 104-2. The message service system generates one or more responses that include a version of the requested message content and transmits the generated responses to the client device. Specifically, the message service system maps the WSP network and the ISP network to a set of processing rules, determines from which access network a request was received, and makes a decision on processing the requested message content as a function of the access network from which the request was received and the mapping of the access networks to the set of processing rules. Message content may be processed by compression and/or other operation. In an embodiment, one or more value added services are performed on message content. In another embodiment, one or more packet modifying services are performed on message content. In an embodiment, the message service system maps the WSP network and the ISP network to a set of compression rules, determines from which access network a request was received, and makes a decision on compressing the requested message content as a function of the access network from which the request was received and the mapping of the access networks to the set of compression rules.

In operation, the smart phone 102 can make an IMAP FETCH command request for a message body, which includes a message attachment, to the message service system 108 via either the WSP network 104-2 or the ISP network 104-2. FIGS. 1B and 1C illustrate examples of operations of the network architecture 100 depicted in FIG. 1A. In the example illustrated in FIG. 1B, the smart phone is connected to the Internet 106 via the WSP network using the WSP interface 110 and obtains an IP address from the block of IP addresses between A.B.0.0 and A.B.255.255 that are assigned to the WSP network. When the smart phone makes an IMAP FETCH to the message service system 108, the message service system determines that the request is received from the WSP network by comparing the source IP address of the request, which is the IP address of the smart phone, with the blocks of IP addresses assigned to the WSP network and the ISP network. In an embodiment, the WSP network tends to have lower download speeds than the ISP network (e.g. the access network 104-2) and the message service system decides that it would be beneficial to compress the requested message content. Therefore, the message service system provides compressed message content to the smart phone.

In the example illustrated in FIG. 1C, the smart phone 102 is connected to the Internet 106 via the ISP network 104-2 using the WLAN interface 112 and obtains an IP address from the block of IP addresses between E.F.0.0 and E.F.128.255 that are assigned to the ISP network. When the smart phone makes an IMAP FETCH to the message service system 108, the message service system determines that the request is received from the ISP network by comparing the IP address of the smart phone with the blocks of IP addresses assigned to the WSP network and the ISP network. The IP address of the smart phone can be assigned to the smart phone for a long period of time such as hours or days. The IP address assigned to the smart phone may not change each time that the smart phone makes a request for message content. In an embodiment, the ISP network tends to have higher download speeds than the WSP network (e.g., the access network 104-1) and the message server decides that it is ok not to compress the requested message content. Therefore, the message service system provides a true copy of the requested message content to the smart phone. The file size of a true copy of the requested message content is same as the file size of the requested message content. In addition, the file format of a true copy of the requested message content is same as the file format of the requested message content. In an embodiment, a true copy of the requested message content is exactly identical with the requested message content in every aspect.

In a conventional messaging system, when a client device, such as a smart phone or a pad computer, fetches an attachment to an email message from a message server, a true copy of the attachment is downloaded from the message server to the client device, regardless of which access network the client device is currently using. In some cases, the attachment may be a large file such as a high resolution image file or a video clip. For example, an image file attachment or a video clip attachment can have a file size in the magnitude ranging from several megabytes to tens of megabytes. Because the fetched attachment can be rather large, the user experience can be negatively impacted if the access network is not able to timely deliver the fetched attachment. Compared with the conventional messaging system, the message service system 108 dynamically processes (e.g. compresses) requested message content according to the access network from which the request was received. For example, if the request is received via a relatively slow wireless service provider network, the attachment can be compressed to a size that can be downloaded reasonably fast (e.g., on the order of a few seconds or over less than one second) and if the request is received via a relatively fast ISP network (via a WLAN connection), the attachment can be provided as a true copy. Because the requested content can be dynamically compressed based on the data rate of the access network from which the request was received, the client device can obtain a version of the requested content that is able to be delivered to the client device in a timely manner, which can enhance the user's experience.

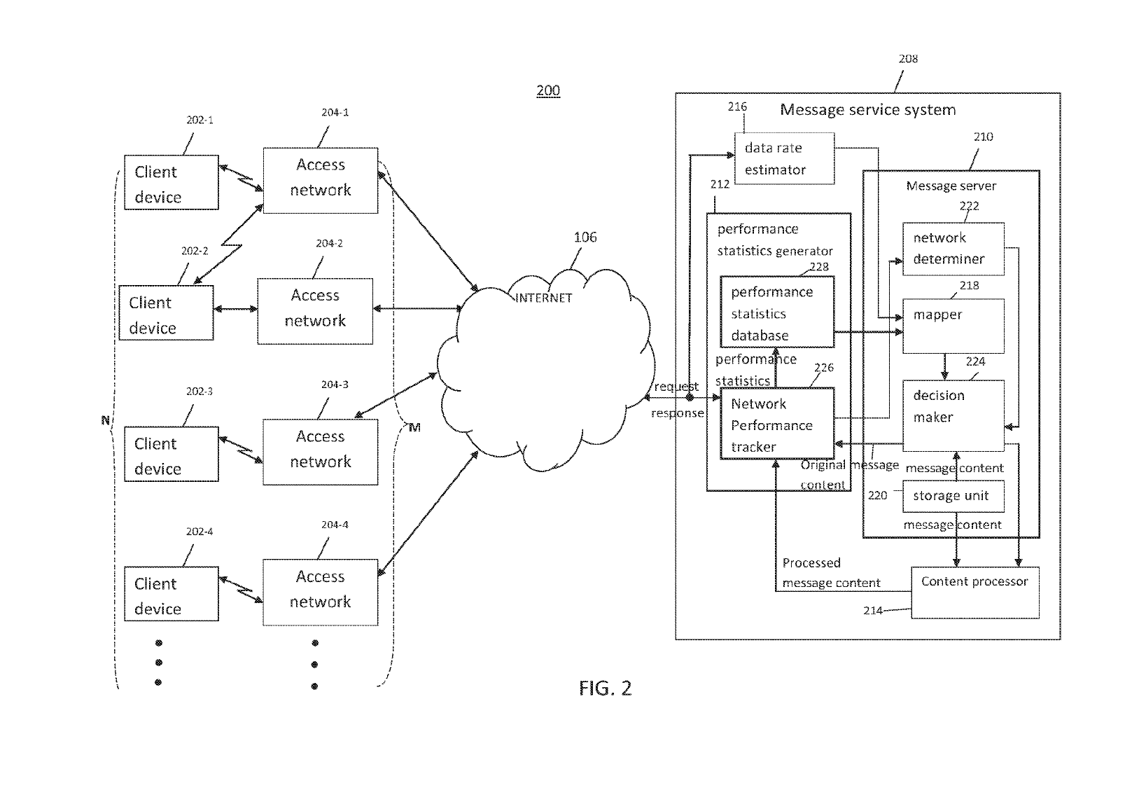

FIG. 2 depicts a schematic block diagram of another embodiment of a network architecture 200 that provides messaging services to client devices. The network architecture depicted in FIG. 2 includes client devices 202-1 . . . 202-N, where N is a positive integer that is larger than one, access networks 204-1 . . . 204-M, where M is a positive integer that is larger than one, the Internet 106, and a message service system 208. Although the network architecture is depicted and described with certain components and functionality, other embodiments of the network architecture may include fewer or more components to implement less or more functionality. For example, the network architecture may include more than one message service system in some embodiments.

Each of the client devices 202-1 . . . 202-N is configured to request message content from the message service system 208 on behalf of a user via one of the access networks 204-1 . . . 204-M. Each of the client devices may be further configured to render received message content for presenting to the user. The user may be a single person, multiple persons, or other entity or entities. In an embodiment, the message content is a non-streaming file. For example, the message content may be a media file, such as an image, a video clip, or other media file, which can be compressed into a compressed file with a smaller file size. Because the file size of the compressed file is smaller than the file size of a true copy of the message content, the compressed file can be delivered to the client in a time duration that is shorter than the time duration needed to deliver the true copy of the message content. The message content may be a message attachment or a file that is embedded into a message. In an embodiment, the network architecture is an email system and the requested message content is an attachment file of an email message or a file that is embedded into an email message. For example, the requested message content may be an image attachment file or a video clip attachment file, which can have a size in the magnitude ranging from several megabytes to tens of megabytes. In another example, the requested message content may be a large graphic file embedded in an email message.

In the embodiment depicted in FIG. 2, each of the client devices 202-1 . . . 202-N is in the communications range of at least one of the access networks 204-1 . . . 204-M. Each of the client devices includes at least one communications interface (not shown) to communicate with at least one of the access networks. At least one of the client devices may include multiple communications interfaces to communicate with more than one of the access networks. In the embodiment depicted in FIG. 2, the client devices 202-1, 202-2 are both in the communications range of the access network 204-1. The client device 202-2 includes two communications interfaces to communicate with the access networks 204-1, 204-2.

Each of the client devices 202-1 . . . 202-N may communicate wirelessly, communicate through wires, or communicate wirelessly and through wires with other entity or entities. In the embodiment depicted in FIG. 2, client devices 202-1, 202-2, 202-3, 202-4 are wireless devices which can wirelessly communicate using electromagnetic signals such as RF communications signals. Each wireless device can support various different RF communications protocols, including without limitation, GSM, Universal Mobile Telecommunications System (UMTS), Code Division Multiple Access (CDMA), Worldwide Interoperability for Microwave Access (WiMax) and communications protocols as defined by the 3^{rd} Generation Partnership Project (3GPP) or the 3^{rd} Generation Partnership Project 2 (3GPP2), 4G Long Term Evolution (LTE) and IEEE 802.16 standards bodies. Although some wireless communications protocols are identified herein, it should be understood that the present disclosure is not limited to the cited wireless communications protocols. In an embodiment, at least one of the client devices may include separate communications interfaces dedicated to different wireless communications protocols. In the embodiment depicted in FIG. 2, at least one of the client devices 202-1, 202-2, 202-3, 202-4 is a handheld wireless device, such as a cell phone, a mobile phone, a smart phone, a pad computer, a Personal Digital Assistant (PDA), a handheld gaming device etc. Although the client devices 202-1, 202-2, 202-3, 202-4 in the embodiment depicted in FIG. 2 are wireless devices, in other embodiments, at least one of the client devices 202-1, 202-2, 202-3, 202-4 is a wired communications device that accesses the Internet 106 via a dial-up connection, a DSL, or a cable modem.

Each of the access networks 204-1 . . . 204-M of the network architecture 200 is configured to facilitate wired and/or wireless communications between one or more of the client devices 202-1 . . . 202-N and the Internet 106. Each of the access networks can also provide interfaces to facilitate communications between the client devices and network entities, such as a Public Switched Telephone Network (PSTN), a Wide Area Network (WAN), Internet servers, hosts, etc. Data signals communicated between the client device and the access networks include, but are not limited to, analog and/or digital signals for any type of messaging communications mode, including text messaging and multimedia messaging.

Each of the access networks 204-1 . . . 204-M may be a cellular access network, such as a 2G, GPRS, EDGE, 3G or 4G wireless service provider network, and/or a wireless/wired access network, such as a dial-up, DSL, or cable modem based ISP network with/without wireless access, which may be provided by one or more WLAN access points. A private enterprise network can also serve as an access network if client devices within the private enterprise network can access the Internet 106 through the private enterprise network. One or more access networks may be administered by a single entity or different entities. For example, one or more access networks may be managed by a single ISP, a single wireless service provider, or a private enterprise. Although some cellular/wireless/wired access networks are identified herein, it should be understood that the present disclosure is not limited to the cited wireless and wireless access networks. In an embodiment, at least one of the access networks includes an Internet gateway (not shown) that provides a gateway for communications between the client devices 202-1 . . . 202-N and or connected to Internet-connected hosts and/or servers in the Internet. The Internet gateway may include a Serving GPRS Support Node (SGSN) and a Gateway GPRS Support Node (GGSN). In the embodiment depicted in FIG. 2, the access networks 204-1, 204-3, 204-4 are cellular/wireless access networks and the access network 204-2 is a wired network.

The message service system 208 is configured to receive one or more requests for message content from the client devices 202-1 . . . 202-N via the access networks 204-1 . . . 204-M. The message service system generates one or more responses that include a version of the requested message content and transmits the generated responses to the client devices. The message service system depicted in FIG. 2 includes a message server 210, a performance statistics generator 212, a content processor 214, and a data rate estimator 216. Although the message service system is depicted and described with certain components and functionality, other embodiments of the message service system may include fewer or more components to implement less or more functionality. For example, the message service system may not include the data rate estimator in some embodiments. In another example, the message service system may include multiple message servers that are distributed in a network. In another example, some combination of the message server, the performance statistics generator, the content processor, and/or the data rate estimator may be integrated in a single device in some embodiments.

The message server 210 of the message service system 208 includes a mapper 218, a storage unit 220, a network determiner 222, and a decision maker 224. Although the mapper, the network determiner, and the decision maker are shown in FIG. 2 as being separated from each other, at least two of the mapper, the network determiner, and the decision maker may be integrated in a single device in some embodiments. In addition, although the mapper, the network determiner, the storage unit, and the decision maker are shown in FIG. 2 as being part of the message server, at least one of the mapper, the network determiner, the storage unit, and the decision maker is not part of the message server in some embodiments. For example, the mapper, the network determiner, and the decision maker are not in same physical package of the message server.

The mapper 218 of the message server 210 is configured to map the access networks 204-1 . . . 204-M to a set of processing rules. In an embodiment, the mapper is configured to map the access networks 204-1 . . . 204-M to a set of compression rules. The storage unit 220 of the message server is configured to store message content. The storage unit may store text files, webpage files, image files, audio files, video files, or any combination thereof. The message server is configured to receive a request for the message content from at least one of the client devices 202-1 . . . 202-N via one of the access networks, wherein the request is made according to a messaging protocol. The message protocol may be any type of messaging protocol. In an embodiment, the messaging protocol is one of Internet Message Access Protocol (IMAP), Post Office Protocol (POP), Multimedia Messaging Service (MMS) protocol, and an Instant messaging (IM) protocol. Examples of IM protocols include, without limitation, Jabber/Extensible Messaging and Presence Protocol (XMPP), AOL Instant Messenger (AIM) protocols that include Open System for CommunicAtion in Realtime (Oscar) protocol and Talk to OSCAR (TOC) protocol, Internet Relay Chat (IRC), Microsoft Notification Protocol (MSNP), Yahoo! Messenger Protocol, Skype protocol, and Session Initiation Protocol for Instant Messaging and Presence Leveraging Extensions (SIMPLE). In an embodiment, the messaging protocol is IMAP and the request is received in an IMAP FETCH command message. In an embodiment, the message server is labeled as a smart email server and is part of a mail web site, such as mail.yahoo.com, gmail.com, or hotmail.com.

The network determiner 222 of the message server 210 is configured to determine from which of the access networks 204-1 . . . 204-M a request for message content was received. In an embodiment, blocks of IP addresses are assigned to the access networks. In this embodiment, the network determiner is further configured to compare an IP address associated with the request with the blocks of IP addresses, and if the IP address associated with the request matches an IP address in one of the blocks of IP addresses, to identify the corresponding access network, which has the matched IP address, as the access network from which the request was received. The IP address associated with the request may be the source IP address of the request. In an embodiment, the source IP address of the request is an IP address from the blocks of IP addresses that are assigned to the access networks. For example, when a communications device, such as the smart phone 102, is connected to the Internet 106 via a particular one of the access networks, the communications device obtains an IP address from the block of IP addresses that are assigned to the particular access network.

The decision maker 224 of the message server 210 is configured to make a decision on processing the requested message content as a function of the access network from which the request was received and the mapping of the access networks 204-1 . . . 204-M to the set of processing rules. In an embodiment, the decision maker is configured to make a decision on compressing the requested message content as a function of the access network from which the request was received and the mapping of the access networks to a set of compression rules. For example, the decision maker is configured to decide whether or not to compress the requested message content. In an embodiment, the decision maker decides that the requested message content needs to be compressed. Once the decision is made to compress the requested message content, the decision maker selects a compression technique based on the compression mapper's mapping of the access networks to the set of compression rules. In an embodiment, the selected compression technique may be a lossless data compression technique that allows the exact original data to be reconstructed from the compressed data. In another embodiment, the selected compression technique may be a lossy data compression technique that only allows an approximation of the original data to be reconstructed from the compressed data. Generally, lossy data compression techniques have better compression rates than lossless data compression techniques. The message server is further configured to cause the requested message content to be compressed by the content processor 214 using the selected compression technique if the decision is made to compress the requested message content. Specifically, the decision maker may inform the content processor of the selected compression technique and the requested message content. After receiving the information from the decision maker, the content processor fetches the requested message content from the storage unit 220, compresses the fetched message content, and transmits the compressed message content to the designated client device via the corresponding access network. In another embodiment, the decision maker decides not to compress the requested message content. In this case, the requested message content is transmitted without compressing. Specifically, the decision maker may fetch the requested message content from the storage unit and transmit the requested message content to the designated client device via the corresponding access network. In an embodiment, the decision maker is further configured to decide not to compress the requested message content if the file size of the requested message content is smaller than a threshold file size and to decide to compress the requested message content if the file size of the requested message content is larger than the threshold file size. In an embodiment, the decision on compressing the requested message content is made solely according to the data rate of the access network from which the request was received. For example, the message server 200 may not have knowledge of any characteristic of the device. In this case, the decision on compressing the requested message content is not made according to a characteristic of the client device. Although some embodiments are described with respect to compression of message content, embodiments of the invention are not limited to compression of message content.

The performance statistics generator 212 of the message service system 208 is configured to generate performance statistics for the access networks 204-1 . . . 204-M. In an embodiment, the mapper 218 is configured to map the access networks to the set of processing rules based on the performance statistics. In the embodiment depicted in FIG. 2, the performance statistics generator includes a network performance tracker 226 and a performance statistics database 228. The network performance tracker is configured to generate the performance statistics for the access networks based on past delivery of content stored at the message server 210. In an embodiment, the network performance tracker is further configured to measure data rates of the access networks based on the past delivery of the message contents and to store the measured data rates of the access networks in the performance statistics database 228. For example, the network performance tracker measures the data rates of the access networks using transport layer information, such as, using a Transmission Control Protocol (TCP) timer. The performance statistics database is configured to store performance statistics of the access networks. In an embodiment, different blocks of IP addresses are assigned to the access networks and the performance statistics database is configured to store the performance statistics as a relationship between the different blocks of IP addresses and the performance statistics.

The data rate estimator 216 of the message service system 208 is configured to estimate data rates of the access networks 204-1 . . . 204-M based on network carrier types of the access networks. The mapper 218 may be further configured to map the access networks to the set of processing rules based on the estimated data rates. The data rate estimator may be optional in some embodiments.

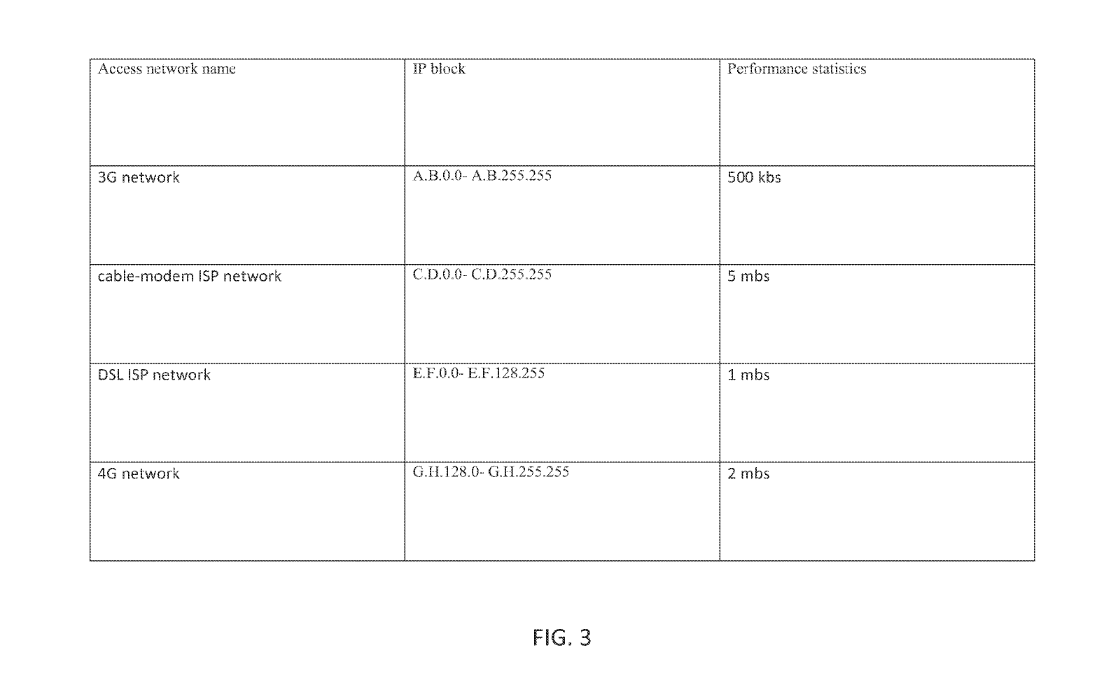

FIG. 3 shows exemplary records in the performance statistics database 228 depicted in FIG. 2. In the exemplary records, the access network 204-1 is a 3G network, which has a data rate of 500 kilobits per second (kbs). The access network 204-2 is a cable-modem ISP network, which has a data rate of 5 megabits per second (mbs). The access network 204-3 is a DSL ISP network, which has a data rate of 1 mbs and a WLAN access. The access network 204-4 is a 4G network, which has a data rate of 2 mbs. Each of the access networks can be assigned a unique block of IP addresses. In the embodiment depicted in FIG. 3, the 3G network 204-1 is assigned a block of IP address between A.B.0.0 and A.B.255.255, the cable-modem ISP network 204-2 is assigned a block of IP address between C.D.0.0 and C.D.255.255, the DSL ISP network 204-3 is assigned a block of IP address between E.F.0.0 and E.F.128.255, and the 4G network 204-4 is assigned a block of IP address between G.H.128.0 and G.H.255.255, where A, B, C, D, E, F, G, and H represent different positive integers. Because each of the access networks is assigned a unique block of IP addresses, the access network that one of the client devices 202-1 . . . 202-N is currently using can be identified by comparing an IP address associated with a request for message content by the client device with the blocks of IP addresses assigned to the access networks. For example, if the IP address associated with the request is A.B.188.175, the 3G network 204-1 is identified to be the access network that the client device is currently using. In another example, if the IP address associated with the request is C.D.166.235, the cable-modem ISP network 204-2 is identified to be the access network that the client device is currently using. In another example, if the IP address associated with the request is E.F.106.153, the DSL ISP network 204-3 is identified to be the access network that the client device is currently using. In another example, if the IP address associated with the request is G.H.149.246, the 4G network 204-4 is identified to be the access network that the client device is currently using.

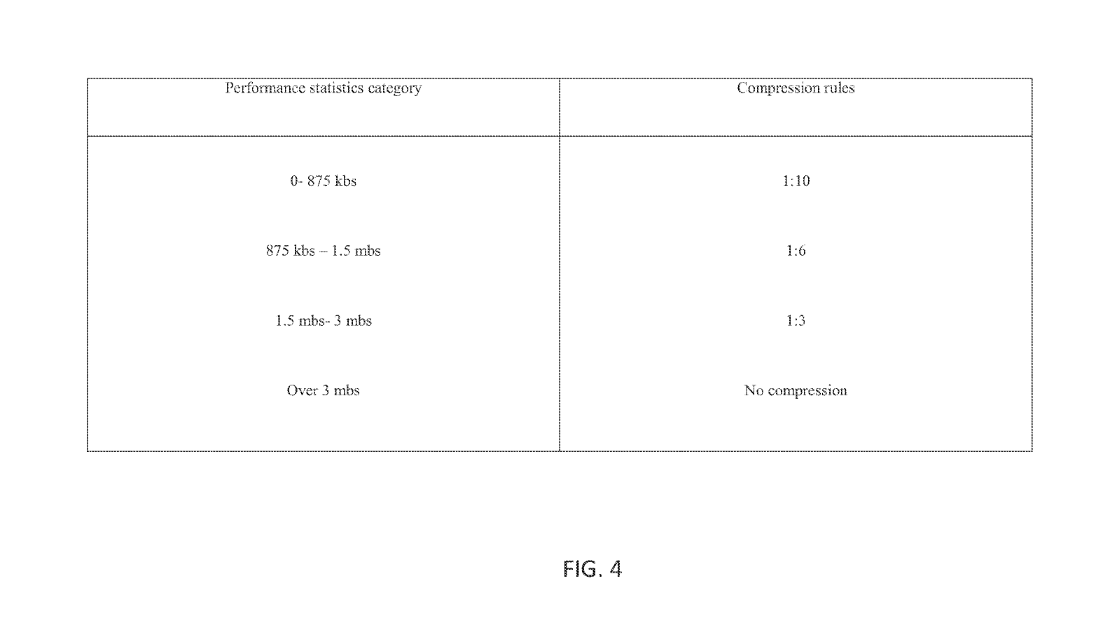

FIG. 4 shows an example mapping of the mapper 218 depicted in FIG. 2. In the example mapping, for an access network with a data rate that is lower than 875 kbs, message content is compressed with a 1:10 compression ratio. That is, the size of the compressed message content is one tenth of the size of the original message content. In addition, in the example mapping, for an access network with a data rate that is equal to or higher than 875 kbs but lower than 1.5 mbs, the requested message content is compressed with a 1:6 compression ratio. Furthermore, in the example mapping, for an access network with a data rate that is equal to or higher than 1.5 mbs but lower than 3 mbs, the requested message content is compressed with a 1:3 compression ratio. Lastly, in the example mapping, for an access network with a data rate that is higher than 3 mbs, the requested message content will not be compressed. For the 3G network 204-1 in FIG. 3, which has a data rate of 500 kbs, the requested message content is compressed with a 1:10 compression ratio. For the cable-modem ISP network 204-2 in FIG. 3, which has a data rate of 5 mbs, the requested message content will not be compressed. For the DSL ISP network 204-3 with WLAN access in FIG. 3, which has a data rate of 1 mbs, the requested message content is compressed with a 1:6 compression ratio. For the 4G network 204-4 in FIG. 3, which has a data rate of 2 mbs, the requested message content is compressed with a 1:3 compression ratio.

The decision on processing (e.g. compressing) requested message content may be made at least partially in accordance to one or more performance metrics of the delivery of the requested message content in its original form or in a compressed form. In an embodiment, the decision on compressing requested message content is made at least in part to satisfy a performance metric, which may be a target download time of the requested message content in its original form or in a compressed form. For example, the decision of whether or not to compress the requested message content can be made such that the download time is within the target download time. In addition, the compression ratio used to compress the requested message content can be chosen such that the download time is within the target download time. Furthermore, the file size and/or a resolution level of the requested message content can be compressed to a certain value/level such that the download time is within the target download time. The target download time may be set to around one second. In an embodiment, a minimum file size and/or a minimum resolution level is specified. In one example, the file size of an image attachment may not be compressed to a level that is below a pre-established threshold. In another example, the pixel resolution (e.g. the number of pixel columns (width) and the number of pixel rows (height)) and/or the spatial resolution (e.g. pixels per inch (ppi)) of the compressed image attachment cannot be below a pre-established threshold. Because the minimum file size and/or the minimum resolution level is specified, a user can obtain an acceptable version of the requested content that is delivered in a timely manner, which can enhance the user's experience.

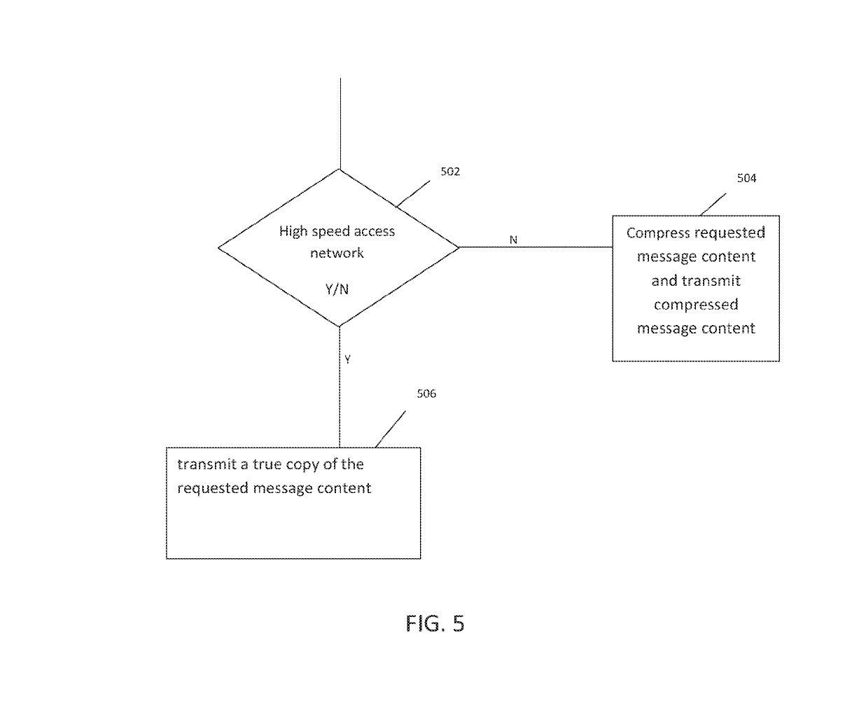

FIG. 5 illustrates example operations of the message service system 208 depicted in FIG. 2. In the example operations, the message server 210 receives a request for the message content from at least one of the client devices 202-1 . . . 202-N via one of the access networks 204-1 . . . 204-M. At block 502, the message server determines whether or not the access network from which the request is received is a high speed network. For example, the mapper 218 compares the data rate of the access network from which the request is received with a threshold data rate. If the data rate of the access network from which the request is received is higher than the threshold data rate, the mapper determines that the access network from which the request is received is a high speed network and the decision maker 224 decides that compression of the requested message content is not needed. If the data rate of the access network from which the request is received is lower than the threshold data rate, the mapper determines that the access network from which the request is received is not a high speed network and the decision maker decides that that compression of the requested message content is needed. The mapper may determine whether or not each of the access networks is a high speed network periodically based on the performance statistics from the performance statistics generator 212 and/or the data rate estimations from the data rate estimator 216. At block 504, if the access network from which the request is received is determined not to be a high speed network, the requested message content is compressed by the content processor 214 and the compressed message content is transmitted to the client device. At block 506, if the access network from which the request is received is determined to be a high speed network, a true copy of the requested message content is transmitted to the client device.

Although the operations herein are shown and described in a particular order, the order of the operations may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

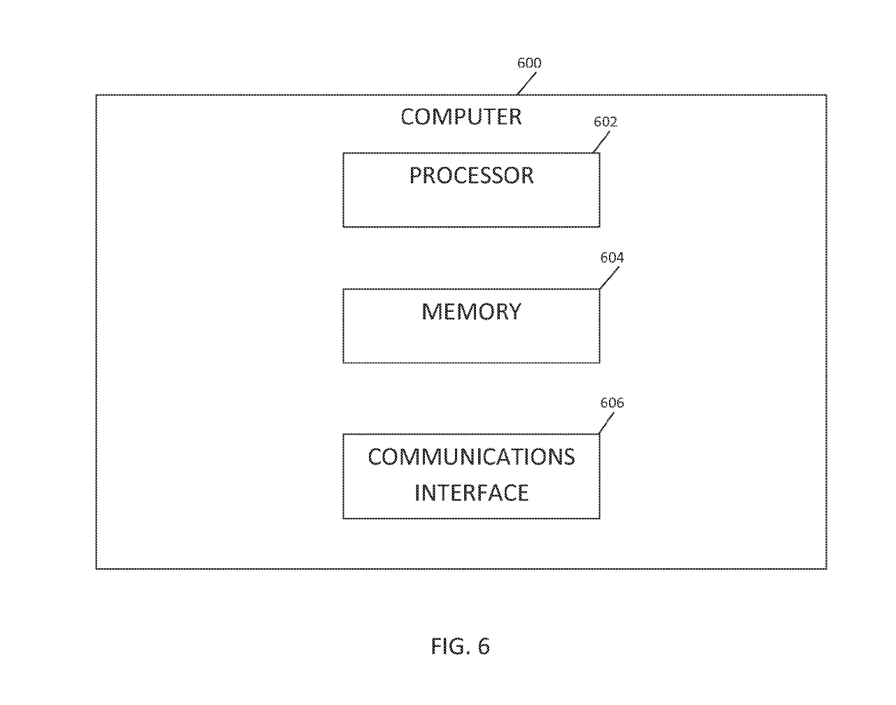

In an embodiment, at least one of the functionalities of components of the network architectures 100 and 200, such as the network architecture 100, the mapper 218, the network determiner 222, and the decision maker 224 of FIG. 2, is performed by a computer that executes computer readable instructions. FIG. 6 depicts a computer 600 that includes a processor 602, memory 604, which is a non-transitory computer-readable medium or a non-transitory computer-readable memory, and a communications interface 606. The processor may include a multifunction processor and/or an application-specific processor. Examples of processors include the PowerPC™ family of processors by IBM and the x86 family of processors by Intel. The memory within the computer may include, for example, storage medium such as read only memory (ROM), flash memory, RAM, and a large capacity permanent storage device such as a hard disk drive. The communications interface enables communications with other computers via, for example, the Internet Protocol (IP). The computer executes computer readable instructions stored in the storage medium to implement various tasks as described above.

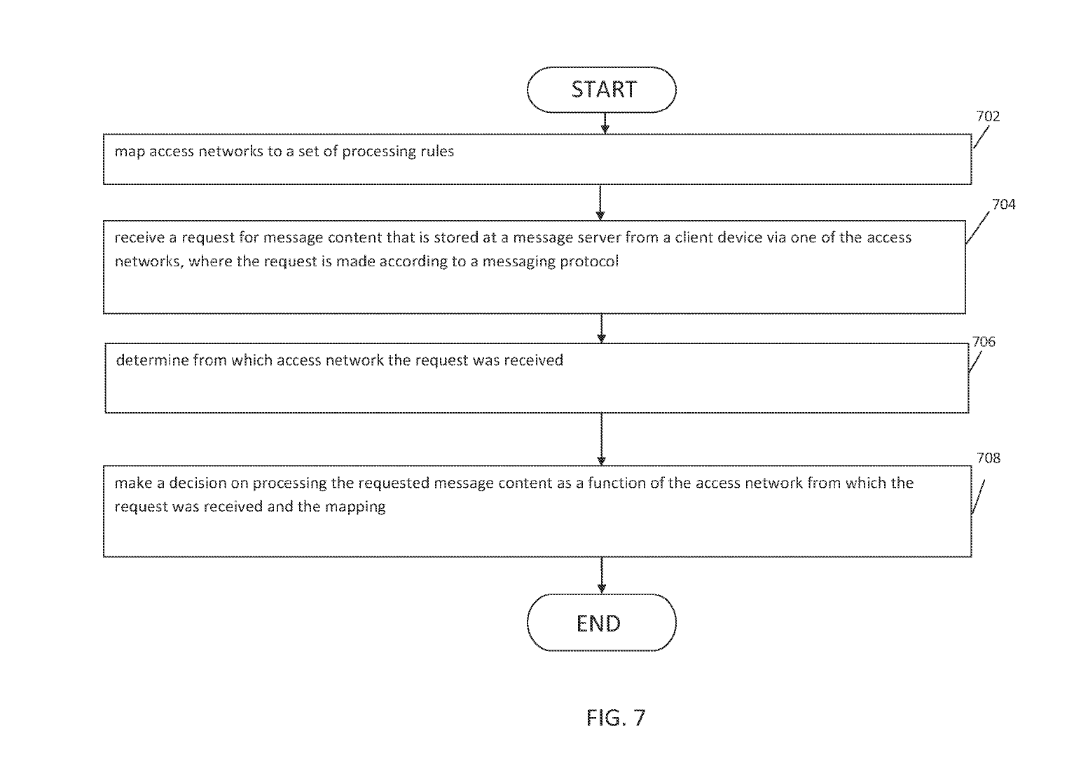

FIG. 7 is a process flow diagram of a method for processing message content that is stored at a message server in accordance with an embodiment of the invention. At block 702, access networks are mapped to a set of processing rules. At block 704, a request for message content that is stored at a message server is received from a client device via one of the access networks, wherein the request is made according to a messaging protocol. At block 706, it is determined from which access network the request was received. At block 708, a decision on processing the requested message content is made as a function of the access network from which the request was received and the mapping.

Embodiments of the invention can be used the delivery of message content, such as non-streamed attachment content and/or embedded content. In addition, embodiments of the invention are also applicable to the delivery of other types of content, e.g., streamed content, Hypertext Transfer Protocol (HTTP) content, etc.

Embodiments of the invention can be used for delivery of message content using other messaging protocols. Although some embodiments of the invention are described with respect to IMAP, POP, MMS, and IM protocols, embodiments of the invention are not limited to IMAP, POP, MMS, and IM protocols.

Embodiments of the invention can be used for processing message content using operations other than or in addition to compression. Although some embodiments of the invention are described with respect to compression of message content, embodiments of the invention are not limited to compression of message content. In an embodiment, one or more value added services are performed on message content. In another embodiment, one or more packet modifying services are performed on message content.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments have been described and illustrated, the invention is not to be limited to the specific forms or arrangements of parts so described and illustrated. The scope of the invention is to be defined by the claims appended hereto and their equivalents.

What is claimed is:

1. A system for processing message content that is stored at a message server, the system comprising:
a mapper configured to map a plurality of access networks to a set of processing rules;
a message server configured to store message content and to receive a request for the message content from a client device via one of the access networks, wherein the request is made according to a messaging protocol;
a network determiner configured to determine from which access network the request was received; and
a decision maker configured to make a decision on processing the requested message content as a function of the access network from which the request was received and the mapping of the plurality of access networks to the set of processing rules.

2. The system of claim 1, wherein the messaging protocol is one of Internet Message Access Protocol (IMAP), Post Office Protocol (POP), Multimedia Messaging Service (MMS) protocol, and an Instant messaging (IM) protocol.

3. The system of claim 1, wherein blocks of Internet Protocol (IP) addresses are assigned to the access networks, and wherein the network determiner is further configured to:
compare an IP address associated with the request with the blocks of IP addresses; and
identify the corresponding access network as the access network from which the request was received if the IP address associated with the request matches an IP address in one of the blocks of IP addresses.

4. The system of claim 1, wherein the decision maker is further configured to:
decide whether or not to compress the requested message content;
select a compression technique based on the mapping if the decision is made to compress the requested message content,
wherein the message server is further configured to cause the requested message content to be compressed using the selected compression technique if the decision is made to compress the requested message content.

5. The system of claim 3, the system further comprising a performance statistics generator configured to:
generate performance statistics for the access networks; and
store the performance statistics as a relationship between the blocks of IP addresses and the performance statistics,
wherein the mapper is further configured to map the plurality of access networks to a set of compression rules based on the performance statistics.

6. The system of claim 5, wherein the performance statistics generator is further configured to:
store the performance statistics as a relationship between the blocks of IP addresses and the performance statistics; and
generate the performance statistics for the access networks based on past delivery of content stored at the message server.

7. The system of claim 1, wherein the mapper is further configured:
compare a data rate of the access network from which the request is received with a threshold data rate;
determine that the access network from which the request is received is a high speed network if the data rate of the access network from which the request is received is higher than the threshold data rate; and
determine that the access network from which the request is received is not a high speed network if the data rate of the access network from which the request is received is lower than the threshold data rate,
wherein the decision maker is further configured to:
decide not to compress the requested message content if the access network from which the request is received is determined to be a high speed network; and
decide to compress the requested message content if the access network from which the request is received is determined not to be a high speed network.

8. A method for processing message content that is stored at a message server, the method comprising:
mapping a plurality of access networks to a set of compression rules;
receiving a request for message content that is stored at a message server from a client device via one of the access networks, wherein the request is made according to a messaging protocol;
determining from which access network the request was received, wherein blocks of Internet Protocol (IP) addresses are assigned to the access networks, and wherein determining from which access network the request was received comprises:
comparing an IP address associated with the request with the different blocks of IP addresses;
identifying the corresponding access network as the access network from which the request was received if the IP address associated with the request matches an IP address in one of the blocks of IP addresses; and
making a decision on compressing the requested message content as a function of the access network from which the request was received and the mapping, wherein making the decision on compressing the requested message content comprises:
deciding whether or not to compress the requested message content; and
selecting a compression technique based on the mapping if the decision is made to compress the requested message content, and
causing the requested message content to be compressed using the selected compression technique if the decision is made to compress the requested message content.

9. The method of claim 8, wherein the messaging protocol is one of Internet Message Access Protocol (IMAP), Post Office Protocol (POP), Multimedia Messaging Service (MMS) protocol, and an Instant messaging (IM) protocol, and wherein the method further comprises:
generating performance statistics for the access networks based on past delivery of content stored at the message server; and
storing the performance statistics as a relationship between the blocks of IP addresses and the performance statistics,
wherein mapping the plurality of access networks to the set of compression rules comprises mapping the plurality of access networks to the set of compression rules based on the performance statistics, and
wherein mapping the plurality of access networks to the set of compression rules comprises:
comparing a data rate of the access network from which the request is received with a threshold data rate;
determining that the access network from which the request is received is a high speed network if the data rate of the access network from which the request is received is higher than the threshold data rate; and
determining that the access network from which the request is received is not a high speed network if the data rate of the access network from which the request is received is lower than the threshold data rate,
wherein deciding whether or not to compress the requested message content comprises:
deciding not to compress the requested message content if the access network from which the request is received is determined to be a high speed network; and
deciding to compress the requested message content if the access network from which the request is received is determined not to be a high speed network.

10. A non-transitory computer-readable medium comprising computer-readable instructions stored thereon, which, when executed by a processing system, cause the processing system to perform a method of processing message content stored at a message server, the method comprising:
mapping a plurality of access networks to a set of processing rules;
receiving a request for message content that is stored at a message server from a client device via one of the access networks, wherein the request is made according to a messaging protocol;
determining from which access network the request was received; and
making a decision on processing the requested message content as a function of the access network from which the request was received and the mapping.

11. A method of processing message content that is stored at a message server, the method comprising:
mapping a plurality of access networks to a set of processing rules;
receiving a request for message content that is stored at a message server from a client device via one of the access networks, wherein the request is made according to a messaging protocol;
determining from which access network the request was received; and
making a decision on processing the requested message content as a function of the access network from which the request was received and the mapping.

12. The method of claim 11, wherein the messaging protocol is one of Internet Message Access Protocol (IMAP), Post Office Protocol (POP), Multimedia Messaging Service (MMS) protocol, and an Instant messaging (IM) protocol.

13. The method of claim 1, wherein blocks of Internet Protocol (IP) addresses are assigned to the access networks, and wherein determining from which access network the request was received comprises:
comparing an IP address associated with the request with the blocks of IP addresses; and
identifying the corresponding access network as the access network from which the request was received if the IP address associated with the request matches an IP address in one of the blocks of IP addresses.

14. The method of claim 13, wherein the IP address associated with the request is the source IP address of the request.

15. The method of claim 11, wherein making a decision on processing the requested message content comprises:
deciding whether or not to compress the requested message content; and
selecting a compression technique based on the mapping if the decision is made to compress the requested message content,
wherein the method further comprises causing the requested message content to be compressed using the selected compression technique if the decision is made to compress the requested message content.

16. The method of claim 11, further comprising generating performance statistics for the access networks, and wherein mapping the plurality of access networks to the set of processing rules comprises mapping the plurality of access networks to a set of compression rules based on the performance statistics.

17. The method of claim 16, wherein blocks of Internet Protocol (IP) addresses are assigned to the access networks, and wherein the method further comprises storing the performance statistics as a relationship between the blocks of IP addresses and the performance statistics.

18. The method of claim 16, wherein generating the performance statistics for the access networks comprises generating the performance statistics for the access networks based on past delivery of content stored at the message server.

19. The method of claim 18, wherein generating the performance statistics for the access networks based on the past delivery of the content stored at the message server comprises:
measuring data rates of the access networks based on the past delivery of the message contents; and
storing the measured data rates of the access networks in a database.

20. The method of claim 19, wherein measuring the data rates of the access networks comprises measuring the data rates of the access networks using transport layer information.

21. The method of claim 19, wherein measuring the data rates of the access networks comprises measuring the data rates of the access networks using a Transmission Control Protocol (TCP) timer.

22. The method of claim 11, wherein mapping the plurality of access networks to the set of processing rules comprises:
comparing a data rate of the access network from which the request is received with a threshold data rate;
determining that the access network from which the request is received is a high speed network when the data rate of the access network from which the request is received is higher than the threshold data rate;
determining that the access network from which the request is received is not a high speed network when the data rate of the access network from which the request is received is lower than the threshold data rate,
wherein making the decision on processing the requested message content comprises:
deciding not to compress the requested message content if the access network from which the request is received is determined to be a high speed network;
deciding to compress the requested message content if the access network from which the request is received is determined not to be a high speed network.

23. The method of claim 11, wherein blocks of Internet Protocol (IP) addresses are assigned to the access networks, and wherein determining from which access network the request was received comprises:
comparing an IP address associated with the request with the blocks of IP addresses; and
identifying the corresponding access network as the access network from which the request was received if the IP address associated with the request matches an IP address in one of the blocks of IP addresses,
wherein making the decision on processing the requested message content comprises:
deciding whether or not to compress the requested message content; and
selecting a compression technique based on the mapping if the decision is made to compress the requested message content,
wherein the method further comprises:
causing the requested message content to be compressed using the selected compression technique if the decision is made to compress the requested message content,
generating performance statistics for the access networks; and
storing the performance statistics as a relationship between the blocks of IP addresses and the performance statistics,
wherein mapping the plurality of access networks to the set of processing rules comprises mapping the plurality of access networks to a set of compression rules based on the performance statistics.

24. The method of claim 11, further comprising estimating data rates of the access networks based on network carrier types of the access networks, wherein mapping the plurality of access networks to the set of processing rules comprises mapping the plurality of access networks to the set of processing rules based on the estimated data rates.

25. The method of claim 11, wherein making the decision on processing the requested message content comprises:
deciding not to compress the requested message content if a file size of the requested message content is smaller than a threshold file size; and
deciding to compress the requested message content if the file size of the requested message content is larger than the threshold file size.
